(19) United States
(12) Patent Application Publication
(10) Pub. No.: US 2005/0041874 A1
(43) Pub. Date: Feb. 24, 2005

(54) Reducing bit rate of already compressed multimedia

(76) Inventors: Gerrit Cornelis Langelaar, Eindhoven (NL); Josephus Adrianus Pijnenburg, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/501,830

(22) PCT Filed: Jan. 13, 2003
(86) PCT No.: PCT/IB03/00057

(30) Foreign Application Priority Data
Jan. 22, 2002 (EP) 02075251.5

(51) Int. Cl. G06K 9/36; G06K 9/46

(52) U.S. Cl. 382/233

(57) ABSTRACT

A method for post-processing a bit stream of compressed multimedia data having been compressed by a process comprising independent compression of non-overlapping blocks of pixels covering the original multimedia data, wherein a bit rate is reduced by randomly discarding some Variable Length Codes (VLCs). The discarded VLCs are merged with subsequent VLCs to reduce bit rate.

### FIELD OF THE INVENTION

The present invention relates to a method for post-processing a signal of already compressed multimedia data in the form of media streams. The present invention is also related to corresponding apparatus, a computer-readable medium, a digital information signal and use of method. As used herein, the term “multimedia” can be any type of media such as video, sound etc, typically distributed in the form of a stream of data packets.

### BACKGROUND

There are several compression methods for processing independent blocks of media bit streams such as JPEG, MPEG, H.320 etc. In the following, a variant of MPEG, MPEG-2 will briefly be further described to exemplify how compression can be achieved. Additional information regarding MPEG-2 standards can be found for instance in MPEG-2 specifications ISO/IEC 13818-1, 2, 3 available from ISO/IEC Copyright Office Case postal 56, CH 1211, Geneva 20, Switzerland, but is not necessary for understanding the invention. Herein, a “media bit stream” is typically a bit stream of video or sound media.

A MPEG-2 video bit stream has a layered structure. Each layer comprises one or more sub-layers. For instance, a video sequence can be divided into multiple groups of pictures, so-called “GOP”:s, representing sets of video frames which are contiguous in display order. In a sub-layer thereof the frames can be split into “slices” and “macro blocks”, which can be further split into yet another sub-layer of blocks.

Three types of frames are used in the MPEG processing: intra frames (I-frames), which are coded without any reference to other frames, predicted frames (P-frames), which are coded with reference to past I- or P-frames, and bi-directionally interpolated frames (B-frames), which are coded with references to both past and future frames. An encoded GOP always starts with an I-frame to provide access points for random access of the video stream.

MPEG-2 specifies that the I-frames are “intra” coded such that the entire picture is broken into 8×8 blocks of pixels, which blocks are typically processed by discrete cosine transform (DCT) and quantized to a compressed set of coefficients that alone represent the original picture. The MPEG-2 specification also allows for the P-frames rather than encoding all of the blocks by DCT, that so-called “motion compensation” is used to exploit a temporal redundancy found in most video data. The motion compensation works in the way that within a GOP a temporal redundancy among the frames is reduced by applying prediction to obtain a difference signal, a so-called prediction error, which is further compressed using DCT to remove spatial correlation. Thereafter the resulting DCT coefficients are quantized. Finally, motion vectors are combined with the DCT information and coded using variable length coding (VLC) to represent the video data by means of variable length codes (VLCs).

By using motion compensation, MPEG-2 dramatically reduces the amount of data storage required, and the associated bit rate without significantly reducing the quality of the image. However, additional bit rate reduction of an already compressed media stream is often required for instance for applications in the field of digital recording and digital networks.

As an example, sometimes digital recorders have to provide some processing that increases the bit rate locally, for instance to create transitions between two video fragments in video editing. To be able to keep the bit rate constant, these recorders therefore need a fine tune bit rate control mechanism that can adjust the bit rate of already compressed media streams for instance by ± 10%.

EP-A2-0 599 257 discloses a video signal recording apparatus and method used for recording or transmitting a video signal that provide bit rate reduction. However, this document describes a video signal recording apparatus and method, suitable for devices in which reproduction errors are frequent, whereby the document describes how to decrease the effect of such defects.

Importantly, the disclosed apparatus and method does not describe how to reduce bit rate by means of a low complex bit rate control method applicable to already compressed streams.

### SUMMARY OF THE INVENTION

An object of the invention is to provide a method and apparatus for post-processing already compressed multimedia streams having been compressed by a process comprising independent compression of non-overlapping blocks of pixels covering the original multimedia data to achieve a reduced bit rate. Herein, the term “pixel” means any spatial resolution element, including but not limited to a smallest distinguishable and resolvable area in an image.

According to an aspect of the present invention the object is realised in a method discarding a selected set of coded transform coefficients. Herein, a “transform coefficient” is a coefficient that changes information in structure or composition without significantly altering the meaning or value.

According to a preferred embodiment of the invention, it is provided a method for post-processing a bit stream of compressed multimedia data having been compressed by a process comprising independent compression of non-overlapping blocks of pixels covering the original multimedia data, said method comprising:
providing an information signal representing the bit stream, said signal comprising coded transform coefficients,
reducing a bit rate of the signal by discarding a selected set of the coded transform coefficients.

An advantage is that the method directly operates on compressed media streams and that no expensive drift-compensation techniques are required to avoid artefacts, typically visible artefacts.

Preferably, discarding a selected set of the coded transform coefficients comprises the steps:
providing a random pattern representing transform coefficients having random signs of (−1, +1),
parsing and partially decoding the bit stream to run-level pairs,
selecting candidate run-level pairs having a level equal to (−1, 1), wherein the run is equal to the number of zeros preceding a certain coefficient and the level is equal to a value of the coefficient,
determining the corresponding random sign (−1, +1),
discarding candidate(s) if a sum of the level of the candidate(s) and the buffer is equal to zero,
merging extra zeros from discarded candidate(s) to a run of a next run-level pair to form a new run-level pair,
generating a new code for the new run-level pair to obtain a new information signal.

In a first aspect of some preferred embodiments of the invention, least significant coefficients are discarded.

In a second aspect of some preferred embodiments of the invention, a set of up to three is discarded.

In a third aspect of some embodiments of the invention, the discarded set is determined by indices in a transform block in response to a target quality.

In a fourth aspect of some preferred embodiments of the invention, the discarded set is determined by having a lower index.

There is further provided, in accordance with a preferred embodiment of the invention, a computer-readable medium provided with program instructions for causing one or more processors to perform: a method for post-processing a bit stream of compressed multimedia data having been compressed by a process comprising independent compression of non-overlapping blocks of pixels covering the original multimedia data, said method comprising:
providing an information signal representing the bit stream, said signal comprising coded transform coefficients,
reducing a bit rate of the signal by discarding a selected set of the coded transform coefficients.

There is further provided, in accordance with a preferred embodiment of the invention, a digital information signal of compressed multimedia data having been compressed by a process comprising independent compression of non-overlapping blocks of pixels covering the original multimedia data, said signal having a reduced bit rate by being provided with a reduced set of coded transform coefficients. Herein, the term “signal” means a conveyor of information, typically an event or electrical quantity that conveys information from one point to another.

There is further provided, in accordance with a preferred embodiment of the invention an apparatus for post-processing a bit stream of compressed multimedia data having been compressed by a process comprising independent compression of non-overlapping blocks of pixels covering the original multimedia data, said apparatus comprising:
buffer means comprising a random pattern representing transform coefficients having random signs of (−1, +1);
decoding/encoding means for analysing and decoding/encoding an incoming/outgoing information signal comprising coded transform coefficients representing the bit stream;
at least one video block, comprising transform coefficients;
control means for controlling the video block, the buffer and the decoder/encoder, wherein the decoding/encoding means parses and partially decodes the stream to run-level pairs, the control means selects candidate(s) run-level pairs having a level equal to (−1, 1), determines the corresponding random sign (−1, +1) from the buffer means, discards candidate(s) if a sum of the level of the candidate and the buffer means is equal to zero, merges extra zeros from discarded candidate(s) to a run of a next run-level pair, the decoding/encoding means generates a new code for the new run-level pair, to provide an outgoing information signal having a selected set of the coded transform coefficients discarded to obtain a reduced bit rate.

Herein, “buffer” can be any storage device provided for compensating for a difference in the rate of flow of information or occurrence of events when transmitting information from one device to another, and is typically a high-speed area of storage.

There is further provided, in accordance with a preferred embodiment of the invention, use of a method according to various embodiments of the invention in a digital network such as the Internet.

A principal aspect of the invention is to provide a method that reduces the bit rate up to 10% without seriously affecting the visual quality. This and other aspects of the invention will be apparent from and elucidated with reference to the embodiments(s) described hereinafter.

### BRIEF DESCRIPTION OF THE DRAWINGS

The present invention will be more clearly understood from the following description of the preferred embodiments of the invention read in conjunction with the attached drawings in which:

FIG. 1 is a schematic representation of an example prior art 8×8 block, which is fully decoded;

FIG. 2a is a block diagram of an apparatus according to a preferred embodiment of the invention,

FIG. 2b is an enlargement of the video block illustrated in FIG. 2a without reduced bit rate.

FIG. 2c is an enlargement of the video block illustrated in FIG. 2a having reduced bit rate.

### DETAILED DESCRIPTION OF PREFERRED EMBODIMENTS

Before describing a preferred embodiment of the invention, a short introduction to MPEG-2 basics will be given for a better understanding of the invention. MPEG-2 basics related to the invention: In MPEG-2, the spatial redundancy in the prediction error in the predicted frames and the I-frames, represented by a luminance component Y and chrominance components U and V, is reduced using the operations described below.

First the chrominance components U and V are sub-sampled. Next, DCT processing is performed on the 8×8 pixel blocks of the Y, U and V components, and the resulting DCT coefficients are quantized. Since the human eye is less sensitive to higher frequencies, the energy in the lower frequencies can be quantized more coarsely.

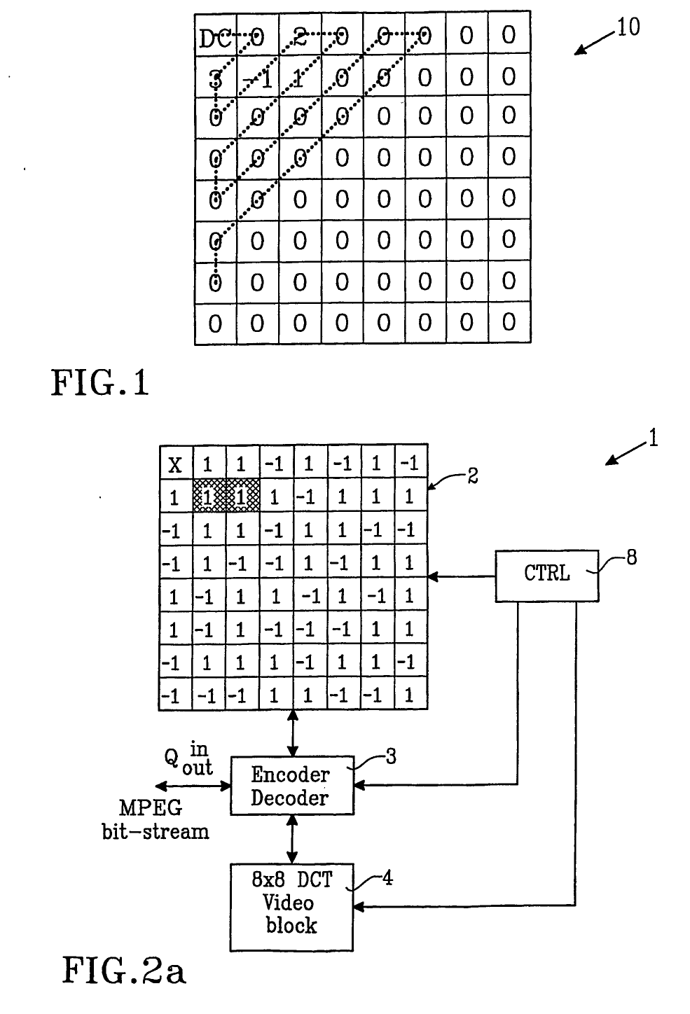

In the lowest MPEG layer, the block layer, the spatial 8×8 pixel blocks are represented by 64 quantized DCT coefficients. This is illustrated in FIG. 1 showing a pixel block 10 having 8×8 integer entries that correspond with the quantized DCT coefficients. Many of the entries are usually zero, especially those entries that correspond with the spatial higher frequencies, which are quantised more coarsely as described above. The 8×8 pixel block shown in FIG. 1 is just an example of how a prior art block could be provided with DCT coefficients

The entry in the upper left comer of the block 10 containing a zero-frequency coefficient with index (0,0) is called a “DC-coefficient”, since it represents an average value of the 8×8 pixel block 10. The other entries of the block representing the quantised DCT coefficients are called “AC coefficients”.

A so-called “zigzag scan” is shown by a line. This scan starts in the upper left comer of the block 10 and continues in the direction indicated by an arrow. Because of simplicity, a complete scan is not shown, but only a part thereof, to describe the principle of so-called “run-level” pairs. Run-level pairs:

The non-zero AC coefficients can be re-ordered and represented by the run-level pairs, where the “run” is equal to the number of zeros preceding a certain coefficient and the “level” is equal to the value of the coefficient. This can be described, in a first step, in the form of a one-dimensional array of quantised AC-DCT coefficients. For instance, from FIG. 1 the array can be represented as (DC, 0, 3, 0, −1, 2, 0, 1, 0, 0, 0, 0, 0, . . . , 0). Subsequently, in a second step, the coefficients are represented as run-level pairs in the form of (run, level) and a marker for end of block (EOB). Using the coefficients from FIG. 1 the representation will look like: (DC), (1, 3), (1, −1), (0, 2), (1, 1), EOB.

Finally, the run-level pairs are entropy coded and represented by VLC code words. The code words for a single DCT-block are terminated by the EOB-marker. Using the coefficients from FIG. 1 the representation will be: (DC), (001001010), (0111), (01000), (01 10), (10).

Preferred Embodiments of the Invention:

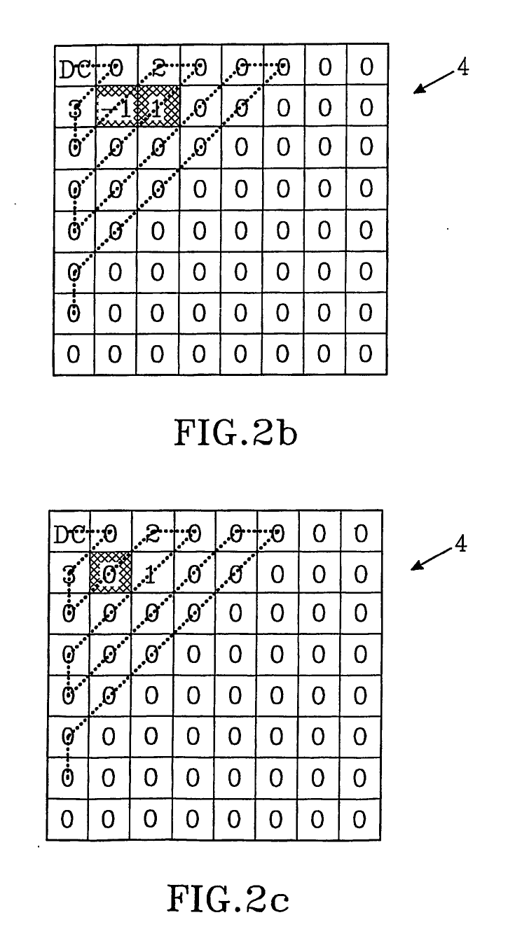

Now a preferred embodiment of the invention will be described in detail. FIG. 2a shows apparatus 1 for post-processing a bit stream of compressed multimedia, in accordance with a preferred embodiment of the invention. Apparatus 1 comprises a random buffer 2 provided with a random pattern representing DCT coefficients. The shown pattern of the random buffer 2 is only an example and is by no means limited to this particular pattern. Any suitable pattern can be employed, typically by being generated by a random generator (not shown). Apparatus 1 further comprises a decoder/encoder 3; in this example comprising an MPEG parser for analysing and decoding an incoming media stream Qᵢₙ, in this example an MPEG bit stream. An outgoing bit stream Qₒᵤₜ is also indicated, starting from the decoder/encoder 3. There is also a video block 4, comprising 8×8 DCT coefficients. The block 4 has access to the decoder/encoder 3. This is illustrated in this figure with a double-headed arrow between video block 4 and the decoder/encoder 3. All method steps that are necessary to perform before arriving at the DCT coefficients in the video block 4 are not shown in this figure, but will be described below in detail referring to FIG. 2b. A controller 8 is provided to control the video block 4, the buffer 2 and the decoder/encoder 3.

To reduce the bit stream, first the buffer 2 is prepared with a random pattern of DCT coefficients. This buffer 2 only comprises random signs (−1, +1). In FIG. 2a, the buffer 2 is shown having an already prepared pattern. Now the MPEG parser in the decoder/encoder 3 parses and partially decodes the incoming media stream Qᵢₙ, typically an MPEG stream. In FIG. 2a, the data of the incoming MPEG stream is not shown, but an already parsed and decoded video block 4 of this stream is shown in FIG. 2b. From the video block 4, in FIG. 2b, it is evident that the MPEG parser will find VLC codes representing the following run-level pairs: (1, 3) (1, −1) (0, 2) (1, 1), . . . ,(10), whereby the run-level pair (10) is EOB. The MPEG parser selects so-called “candidate pairs”, i. e. in this particular example the pairs (1, −1) and (1, 1), which are shadowed. Candidate pairs are pairs that are a run-level pairs with a level equal to either −1 or 1. According to the random buffer 2, in which the selected DCT coefficients are shadowed, the level of both coefficients should be increased to embed a watermark. The run-level pairs are: DC, (1, 3), (1, −1), (0, 2) (1, 1), EOB. Thus, the second candidate run-level pair (1, 1) will become (1, 2). However, the first candidate run-level pair (1, −1) will become (1, 0). This means that this run-level pair disappears, since the sum of the level of the VLC and the sign from the random buffer is equal to zero. The run of 1 zero and the coefficient that became zero by the hereinafter described run-merge method are added to the next run-level pair (0, 2), which then becomes (2, 2). The resulting VLCs for the sequence (1, 3) (2, 2) (1, 1) (EOB) are re-generated by the decoder/encoder 3 and can be transmitted as an outgoing stream Qₒᵤₜ.

In other words the merge can be described as: extra zeros resulting from discarded VLC are merged to the run of the next run-level pair. Finally, the new VLC code is generated for this new run-level pair.

In an alternate method, a set of least significant coefficients is discarded, for instance 3 per 8×8 DCT block, whereby the bit rate can be reduced up to about 10% without seriously affecting the video quality.

The indices in a transform block can also be in response to a target quality, for instance by defining total allowed changes and/or by a quantisation step. The discarded set can also be determined by having a lower index.

Preferably, decoder/encoder and method steps are partially or completely software only solutions.

The processing operations performed by the present invention are next generally described.

The method steps that are provided according to a preferred embodiment of the invention are the following:
providing a random pattern representing transform coefficients having random signs of (−1, +1),
parsing and partially decoding the bit stream to run-level pairs,
selecting candidate run-level pairs (candidate(s)) having a level equal to (−1, 1), wherein the run is equal to the number of zeros preceding a certain coefficient and the level is equal to a value of the coefficient,
determining the corresponding random sign (−1, +1),
discarding candidate(s) if a sum of the level of the candidate(s) and the buffer is equal to zero,
merging extra zeros from discarded candidate(s) to a run of a next run-level pair to form a new run-level pair,
generating a new code for the new run-level pair to obtain a new information signal.

These steps can be implemented by various hardware configurations other than described above by reference to FIG. 2a For example, the steps can be implemented with individually dedicated components, or by one or more special software routines running on general-purpose hardware, perhaps optimised for image decoding/encoding. An implementation could for instance be one or more processors for decoding images and performing the operations of the present invention, for instance embodied as one or more RAM modules for storing image data and/or program instructions, optionally one or more ROM modules for storing program instructions, one or more I/O interface devices for communicating with other systems, and one or more busses for connecting these individual components. Advantageously, the processors comprise one or more digital signal processors such as TM-1000 type DSP (Philips Electronics North America Corp.) or similar.

In the embodiments of the invention where the processing operations are implemented in software, the present invention further comprises computer readable medium or media, on which recorded or encoded program instructions for causing one or more processors to perform the processing operations are provided. Such media can include magnetic media, such as floppy discs, hard discs, tapes, and so forth, and other media technologies usable in the art such as semi-conductor memories.

Software only solutions can for instance be provided for post-processing of e.g. DIVX movies. For instance, a fast post-processing method can fine tune the size of a DIVX file so that it fits on one CD instead of re-running a complete encoding process to fit it in since it might just be a few megabytes too large before post-processing.

An aspect of the present invention is to commit to hardware those tasks that consume the larger amount of processing time without significantly increasing the hardware cost. Thus, a very cost-competitive hybrid solution that combines the performance of a hardware solution and the cost and simplicity of a software solution can also be employed.

The invention is not in any sense limited to MPEG-2 video, but also other MPEG versions, for instance MPEG-4 (for instance DIVX movies) and audio standards can be covered in a similar way. For instance Dolby AC-3 audio techniques are not described as an example in this document, but is within the scope of the invention. Also combinations of video post-processing according to the invention and conventional audio processing can be applied and is therefore also within the scope of the invention. Since the bit rate for an MPEG-2 video signal is typical 5-9 Mb/second, whereas a compressed audio signal has a bit rate that is significantly lower, for instance 384 Kb per second, such a combination can be preferred.

Also the size of the video block 8×8 is just an example relating to the MPEG-2 specification, and consequently any suitable size may be applied, for instance if another compression method than MPEG-2 is used. Another example of block size could for instance be 16×16.

A multimedia stream typically includes various system information, video information and audio information. In a system, this normally requires: stream parsing stage(s), video processing stage(s) and audio processing stage(s); however, this it not disclosed in this document since the function of these stages are well known for a person skilled in the art. Problems with combining and/or splitting video and audio streams and corresponding timing information handling is also not disclosed in this document, since they are well known for a person skilled in the art. For instance the ISO/IEC 13818 standard describes how a decoder can be embodied.

This document does not disclose other post-processing techniques such as error correction, bit diddling, or other methods for increasing packing density, since they are well known within this field of technology. However, this does not exclude such techniques to be implemented together with the invention without departing from the scope of invention as defined by the claims.

Since transform coefficients are discarded the size of the run-merged stream will always be smaller than the size of the original stream. Locally the bit rate might increase, but typically on average the bit rate decreases 8-10%. Also, to keep start-codes byte-aligned, stuffing bits can be added before each start-code in the MPEG stream.

The present invention can also be implemented in DVD technology, multimedia PC environments, and other home entertainment products based on such architecture. In such implementations, for instance in PCs, the invention can be implemented in processors and/or other hardware components or as a software only solution.

The method according to the invention can also be applied as a post-processing method for adapting digital media streams in digital networks such as MPEG-4 media streams to a so-called real time protocol (TP) used by the Internet, wherein a synchronisation layer may also be included as interface between MPEG-4 media layers and RTP stack.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for post-processing a bit stream of compressed multimedia data having been compressed by a process comprising independent compression of non-overlapping blocks of pixels covering the original multimedia data, said method comprising:
providing an information signal (Q) representing the bit stream, said signal (Q) comprising coded transform coefficients,
reducing a bit rate of the signal (Q) by discarding a selected set of the coded transform coefficients.

2. A method according to claim 1, wherein discarding a selected set of the coded transform coefficients comprises the steps:
providing a random pattern representing transform coefficients having random signs of (−1, +1),
parsing and partially decoding the bit stream to run-level pairs,
selecting candidate run-level pairs (candidate(s)) having a level equal to (−1, 1), wherein the run is equal to the number of zeros preceding a certain coefficient and the level is equal to a value of the coefficient,
determining the corresponding random sign (−1, +1),
discarding candidate(s) if a sum of the level of the candidate(s) and the buffer is equal to zero,
merging extra zeros from discarded candidate(s) to a run of a next run-level pair to form a new run-level pair,
generating a new code for the new run-level pair to obtain a new information signal (Q).

3. A method according to claim 2, wherein a set of least significant coefficients is discarded.

4. A method according to claim 3, wherein a set of up to three is discarded.

5. A method according to claim 2, wherein the discarded set is determined by indices in a transform block in response to a target quality.

6. A method according to claim 2, wherein the discarded set is determined by having a lower index.

7. A method according to claim 2, wherein the discarded set is determined by total allowed changes.

8. A method according to claim 2, wherein the discarded set is determined by a quantization step.

9. A computer-readable medium provided with program instructions for causing one or more processors to perform the method of claim 1.

10. A digital information signal (Q) of compressed multimedia data having been compressed by a process comprising independent compression of non-overlapping blocks of pixels covering the original multimedia data, said signal (Q) having a reduced bit rate by being provided with a reduced set of coded transform coefficients.

11. An apparatus (1) for post-processing a bit stream of compressed multimedia data having been compressed by a process comprising independent compression of non-overlapping blocks of pixels covering the original multimedia data, said apparatus (1) comprising:
buffer means (2) comprising a random pattern representing transform coefficients having random signs of (−1, +1);
decoding/encoding means (3) for analysing and decoding/encoding an incoming/outgoing information signal (Q) comprising coded transform coefficients representing the bit stream;
at least one video block (4), comprising transform coefficients;
control means (8) for controlling said video block(s) (4), the buffer means (2) and the decoding/encoding means (3), wherein the decoding/encoding means (3) parses and partially decodes the stream to run-level pairs, the control means (8) selects candidate(s) run-level pairs having a level equal to (−1, 1), determines the corresponding random sign (−1, +1) from the buffer means (2), discards candidate(s) if a sum of the level of the candidate and the buffer means (2) is equal to zero, merges extra zeros from discarded candidate(s) to a run of a next run-level pair, the decoding/encoding means (3) generates a new code for the new run-level pair, to provide an outgoing information signal (Q) having a selected set of the coded transform coefficients discarded to obtain a reduced bit rate.

12. An apparatus for recording a digital image information signal (Q) of compressed multimedia data having been compressed by a process comprising independent compression of non-overlapping blocks of pixels covering the original multimedia data, said apparatus comprising an apparatus (1) for post-processing a bit stream of compressed multimedia according to claim 11.

13. Use of a method according to claim 1 in a digital network such as the Internet.
